(19) United States
(12) Patent Application Publication
(10) Pub. No.: US 2007/0143404 A1
(43) Pub. Date: Jun. 21, 2007

(54) Method and system for establishing and maintaining data communication between a first and a second local area network

(75) Inventors: Björn Mattiasson, Kungsbacka (SE); Markus Wahl, Vastra Frolunda (SE); Martin Sjoblom, Saro (SE)

Correspondence Address: NIXON & VANDERHYE, PC, 901 NORTH GLEBE ROAD, 11TH FLOOR, ARLINGTON, VA, 22203, US

(73) Assignee: TELEFONAKTIEBOLAGET LM ERICSSON (PUBL), Stockholm (SE)

(21) Appl. No.: 10/582,235

(22) PCT Filed: Dec. 17, 2003
(86) PCT No.: PCT/SE03/01966

§ 371 Date: Jun. 9, 2006

(51) Int. Cl. G06F 15/16

(52) U.S. Cl. 709/205

(57) ABSTRACT

The invention discloses a method for establishing communication between a first party (C1) offering a service, and a second party (C2) needing said service, the parties being in respective LAN:s, unable to establish communication with each other. The first party registers with a switchboard function (SWB) which assigns it an address. The first party registers its address and its service with a name service (NS), and the second party notifies the name service that it desires to utilize a service, and the character of the service. The second party receives the address information to the first party from the name service, the name service having matched the desired service with the offered service, and the second party transmits all or parts of said address information to the switchboard function, with the switchboard function assisting in the establishing of communication between the first and the second party.

### TECHNICAL FIELD

The present invention relates to a method and a system for establishing data communication between a first party that can offer a certain service, and a second party desiring to utilize said certain, where the first and the second parties are arranged in respective first and second Local Area Networks (LAN) and for this reason are unable to establish direct communication with each other.

### BACKGROUND OF THE INVENTION

In modern data networks, there can exist a variety of Local Area Networks (LAN:s), where each LAN comprises a number of parties and/or users of the system. Some or all of the parties in one of the LAN:s can have one or more services to offer to other users, where those users who wish to take advantage of a service being offered might be located in another LAN.

For a number of reasons, the party who has a service to offer and a party wishing to utilize said service may not be able to establish communication with each other, or might not, in fact, be aware of each others existence.

### SUMMARY OF THE INVENTION

As described above, there is thus a need for a method and a system by means of which data communication can be established between a first party that can offer a first service during said data communication, and a second party desiring to utilize said first service, where the first and the second parties are arranged in respective first and second Local Area Networks (LAN) and are unable to establish direct communication with each other.

This need is addressed by the present invention in that it discloses a method which comprises the first party registering itself with a switchboard function (SWB), and the switchboard function (SWB) assigning an address to the first party.

The method further comprises the first party registering its address and the character or identity of its first service with a name service, and the second party notifying the name service that it desires to utilize a service, and the character of the service it desires to utilize. The second party receives the address information to the first party from the name service, the name service having matched the desired service with the offered service, and the second party transmits all or parts of said address information to the switchboard function, with the switchboard function assisting in the establishing of communication between the first and the second party.

The advantages of the invention will become more apparent from the following detailed description.

### DRAWINGS

The invention will be described in more detail in the following, with reference to the appended drawings, in which

FIG. 1 schematically shows a system where the present invention is applied.

### EMBODIMENTS

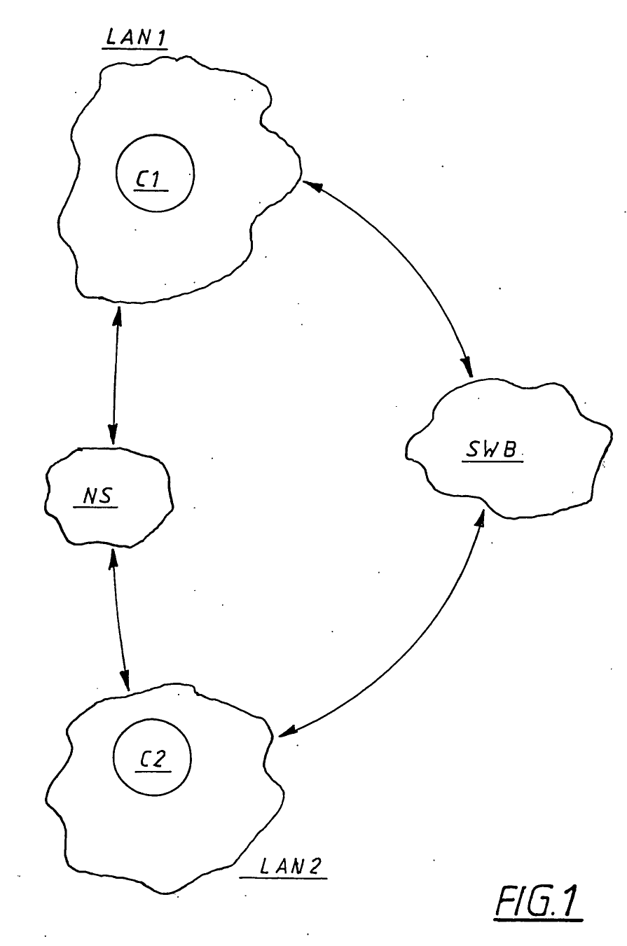

In FIG. 1, a system in which the present invention can be applied is shown. The system comprises a number of Local Area Networks, one of them being shown and referred to as LAN1.

This Local Area Network, LAN1, comprises a number of users. One of the users in LAN1 is shown, referred to as C1 (“computer 1”). C1, as well as possibly a number of the other members of LAN1, can offer a service or provide information to other users. Examples of such a service or information are the position of C1, its velocity, etc., although other services and other information can also be used within a system using the method of the invention.

The services or information offered by C1 is, however, restricted to other members of LAN1, due to the fact that the members of LAN1 cannot readily communicate with members of other LAN:s within the system shown in FIG. 1, which is caused by the system topography being such that the addresses of the members of LAN1 are not available to the outside world, i.e. to users outside of LAN1. This could also be expressed by saying that the addresses within LAN1 are not valid outside of LAN1.

This is only mentioned as an example, there can be other reasons for an inability to communicate between the various LAN:s which would cause one of the problems that are addressed by the present invention.

In another of the LAN:s within the system shown in FIG. 1, the other LAN being referred to as LAN2, there also exist a number of users, one of which is shown in FIG. 1, and referred to as C2 (“computer 2”).

C2 may or may not have the ability to offer to other users one or several services such as the ones mentioned by way of example in connection with C1 and LAN1. However, C2 does not have one of the specific services offered by C1, and thus, when the need arises for C2 to use one of those services, C2 needs to communicate with another computer which can offer that specific service.

Through an internal mechanism in LAN2 which will not be described in detail here since it is not an integral part of the invention, it is established that there are no members of LAN2 which can offer the service sought by C2. Thus, C2 needs to address those LAN:s which are comprised in the system, but are outside of LAN2, to see if the service needed can be found there. Another case could be that C2 needs to address a user outside of LAN2 which it has been in communication with previously.

The service sought by C2 is in fact one of the services offered by C1. However, due to the earlier described inability to communicate between LAN:1 and LAN:2, C2 is not aware of this fact, nor is C1 aware of the fact that one of its services is needed by a computer outside of LAN:1.

By means of the present invention, the following takes place: The system to which the present invention is applied makes use of a so called switching service or “switchboard”, the details of which as such are known, and which will thus not be described in more detail here. This service will be referred to as the switchboard function, SWB, and is shown in the system in FIG. 1.

At a chosen point in time, for example at start-up of C1, C1 registers with the SWB, and receives an address which is “global”, i.e. can be used by users outside of LAN1. Naturally, C1 can register more often than this, if necessary.

The system to which the present invention is applied also makes use of a so called name service, referred to as NS.

When C1 has received its address from the SWB, C1 registers its address and the service or services (or function/functions or information) which it can offer to other users with the name service, NS. As will become apparent from this, the difficulties in communicating between different LAN:s are not of such a nature that they prevent the computers or users in the various LAN:s from contacting the SWB or the NS.

When C2 realizes that it needs a specific service, C2 initiates a communication with the name service. Comprised in this communication is the need that C2 has for a service, as well as the nature of the service sought. The name service reacts by matching the desired service with a party that can offer said service, i.e. in this case C1, and provides C2 with the address information to C1, as well as the information that C1 can provide the service needed by C2.

At this stage, C2 will turn to the switchboard function, SWB, used by the system, which will assist C2 in establishing communication with C1, said communication being aimed at letting C1 carry out the service needed by C2.

The assistance offered by the switchboard function in establishing the communication can be of various kinds. In one embodiment, the SWB acts as a true switchboard, and transmits the traffic between C1 and C2.

As an alternative to letting SWB transmit the traffic between the two parties, one of the parties, e.g. C2 can transmit its address to C1 via SWB, following which C1 utilizes this address to establish direct communication with the first party, i.e. establishing a direct connection between LAN1 and LAN2 by means of the address which C1 received from the SWB, the address thus being a “global address”, which allows the described connection to be established.

1. A method for establishing data communication between a first party that can offer a first service or information during said data communication, and a second party desiring to utilize said first service or information, where the first and the second parties are arranged in respective first and second Local Area Networks, and are unable to establish direct communication with each other, the method comprising:
the first party registering itself with a switchboard function,
the switchboard function assigning an address to the first party, the method being characterized in that it further comprises
the first party registering its address and the character or identity of its first service with a name service,
the second party notifying the name service that it desires to utilize a service, and the character of the service it desires to utilize,
the second party receiving the address information to the first party from the name service, the name service having matched the desired service with the offered service,
the second party transmitting all or parts of said address information to the switchboard function, with the switchboard function assisting in the establishing of communication between the first and the second party.

2. The method of claim 1, according to which the switchboard function transmits the traffic between the first and the second party.

3. The method of claim 1, according to which the first party transmits its address to the second party via the switchboard function, following which the second party utilizes this address to establish direct communication with the first party.

4. A system for data communication, comprising a first LAN with a first party that can offer a first service during said data communication, and a second LAN with a second party desiring to utilize said first service, where the first and the second parties are unable to establish communication directly with each other, the system comprising:
means for letting the first party register itself with a switchboard function,
means for letting the switchboard function assign an address to the first party,
the system being characterized in that it further comprises
means for letting the first party register its address and the character or identity of its first service with a name service,
means for letting the second party notify the name service that it desires to utilize a service, and the character of the service it desires to utilize,
means for letting the second party receive the address information to the first party from the name service, the name service having means for matching the desired service with the offered service,
means for letting the second party transmit all or parts of said address information to the switchboard function, with the switchboard function having means for assisting in the establishing of communication between the first and the second party.

5. The system of claim 4, in which the switchboard function comprises means for transmitting the traffic between the first and the second party.

6. The system of claim 5, in which the first party comprises means for transmitting its address to the second party via the switchboard function, the second party comprising means for subsequently utilizing this address to establish direct communication with the first party.
